(19) United States
(12) Patent Application Publication
(10) Pub. No.: US 2004/0054638 A1
(43) Pub. Date: Mar. 18, 2004

(54) Automatic system for decision making by a virtual or physical agent and corresponding method for controlling an agent

(76) Inventors: Vincent Agami, Paris (FR); Jean-Yves Donnart, Paris (FR); Bruno Heintz, Paris (FR)

Correspondence Address: YOUNG & THOMPSON, 745 SOUTH 23RD STREET 2ND FLOOR, ARLINGTON, VA, 22202

(21) Appl. No.: 10/312,985

(22) PCT Filed: Jul. 5, 2001
(86) PCT No.: PCT/FR01/02165

(30) Foreign Application Priority Data
Jul. 5, 2000 (FR) 00/08760

(51) Int. Cl. G06F 17/00; G06N 5/02; G06F 19/00

(52) U.S. Cl. 706/46; 700/245

(57) ABSTRACT

The invention concerns an automatic system for decision making by a virtual or physical agent on the basis of external variables derived from an environment described by a digital model, and variables internal to the agent described by digital parameters, comprising means for selecting actions to be carried out by the agent based on a variation of one or several of said variables. The digital parameters describing the virtual or physical agent include digital data representing the agent's motivation. The virtual or physical agent's selection of actions is also based on the value of said data representing the agent's motivation.

The present invention relates to the field of artificial intelligence, and more specifically, to automatic systems for decision-making affecting a virtual or physical agent, for example a robot.

More specifically, the present invention relates to a system allowing the actions of an autonomous agent and the way in which this agent learns to behave in its environment to be automatically selected.

More particularly, the invention relates to an automatic system for decision-making by a virtual or physical agent as a function of external variables derived from an environment described by a digital model, and from variables internal to the agent described by digital parameters, comprising means for selecting actions to be carried out by the agent based on varying one or more of said of the variables.

This didactical machine for agents comprises learning means operating on an environment in which the agent is located and preparing behavior information and means of predicting modifications to the environment using the learning means so as to be aware of the environment in which the agent is located in order to be able to predict the modifications or changes to the environment.

A responsibility or reward/punishment signal is generated in order to weight the behavior information of the learning means and in order thus to generate the behavior affecting the environment. The fewer the errors in the prediction means, the greater the responsibility signal must be.

In a nonlinear and unstable environment, for example in the environment of a control object or of a system, no specific teaching signal is given. The states of the various optimum environment and behaviors for the operating modes are switched and combined. One behavior type can be flexibly learnt without prior knowledge.

In the prior art, an information system in which agents are subjected to actions depending on proximity and external stimuli descriptors is known, in particular from the document JP6161551.

Although allowing an agent's behavior to be modified as a function of external stimuli, and in general as a function of the environment as it is perceived by the agent, this system is not suitable for adapting the agent's behavior as a function of variables which are internal thereto.

The aim of the present invention is to alleviate this drawback and to provide an improved system and automatic method making it possible to generate computing tools simulating autonomous changes in the agent which is close to reality.

Another aim of the invention is to provide an automatic system for decision-making affecting a virtual or physical agent, and a corresponding method, making it possible to provide a user with software tools suitable for allowing him to configure the agent or agents as a function of various types of behavior to be obtained by the agent, in particular as a function of its state and of the environment in which it is located, especially as a function of the perception that it has thereof.

To this end, depending on its most general acceptation, the invention relates to an automatic system for decision-making by a virtual or physical agent as a function of external variables derived from an environment described by a digital model, and of variables internal to the agent described by digital parameters, comprising means for selecting actions to be carried out by the agent based on varying one or more of said variables, characterized in that the digital parameters describing the virtual or physical agent include digital data representing the agent's motivation, and in that the virtual or physical agent's selection of actions is also based on the value of said data representing the agent's motivation.

According to another characteristic of the invention, the system comprises a means for changing the value of at least some of the motivation data with time.

Advantageously, the virtual or physical agent includes at least one personality parameter, the system comprising computing means in order to change the value of at least some of the motivation data as a function of the value of said personality parameters.

According to another characteristic of this system, it includes means for configuring at least one variable for the agent's perception and/or knowledge and computing means in order to change the value of at least some of the motivation data as a function of the value of said perception and/or knowledge parameters.

According to yet another characteristic of this system, it includes computing means in order to change the value of at least some of the motivation data of a virtual or physical agent as a function of the result of an action of said agent or of other agents or as a function of the environment.

Preferably, it includes a behavior database associated with the virtual agent or agents, each type of behavior being defined by a set of computing routines and by parameters determining the effect on at least one type of motivation, and computing means for selecting one type of behavior or a sequence of behaviors acting on a virtual or physical agent as a function of the result of a function of changing the motivation data of said virtual or physical agent.

In a particular embodiment, the system includes computing means for periodically updating variables of one or more interacting virtual agents, and for periodically selecting actions applied to the agent or to each of said agents.

According to another advantageous embodiment, the system is provided with a database comprising a plurality of agents, each one described by a class, by data for motivation, behavior, actions, events perceived by the agent, personality and knowledge.

The system may in addition include a motivation database comprising a plurality of motivation files each one comprising data relating to the triggered types of behavior, to the effect of the events perceived by the agent and to the effect of the agent's personality.

According to yet another embodiment, the system is provided with a behavior database comprising a plurality of behavior files each one comprising data relating to the triggered behavior sequences, to the lists of triggered actions, to the effect of the agent's personality and the effect of the agent's knowledge.

In addition, it may include an action database comprising a plurality of action files each one comprising data relating to the consequences of the action on the environment and to the consequences of the action on the types of motivation.

According to yet another variant, the system includes a database for describing the world in which the virtual agents operate.

It may also include a scenario database.

According to yet another characteristic, it includes means for learning at least some of the internal variables.

The subject of the invention is also a method of managing the operation of a virtual or physical agent, which comprises configuring and modeling the agent, configuring and modeling an environment in which the agent is located, preparing variables external and internal to the agent, and selecting actions as a function of variations in one or in several external or internal variables.

According to one aspect of this method, modeling the agent comprises preparing and configuring digital data representing the agent's motivation, and in that selecting actions for the virtual or physical agent comprises selecting said actions as a function of the value of said data representing the agent's motivation.

Other aims, characteristics and advantages of the invention will become apparent from the following description, given solely by way of nonlimiting example and made with reference to the appended drawings in which:

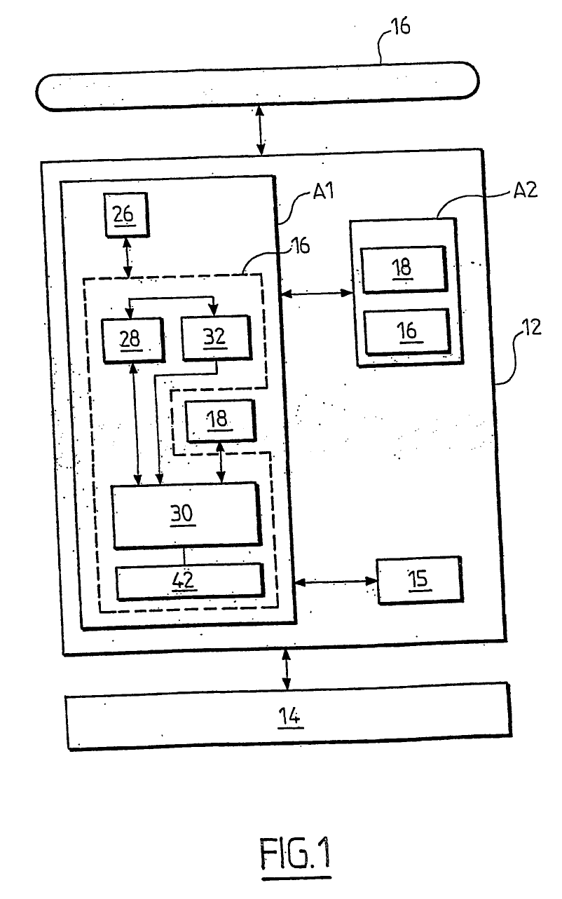

FIG. 1 is a block diagram illustrating the general structure of a system according to the invention, as configured by a user;

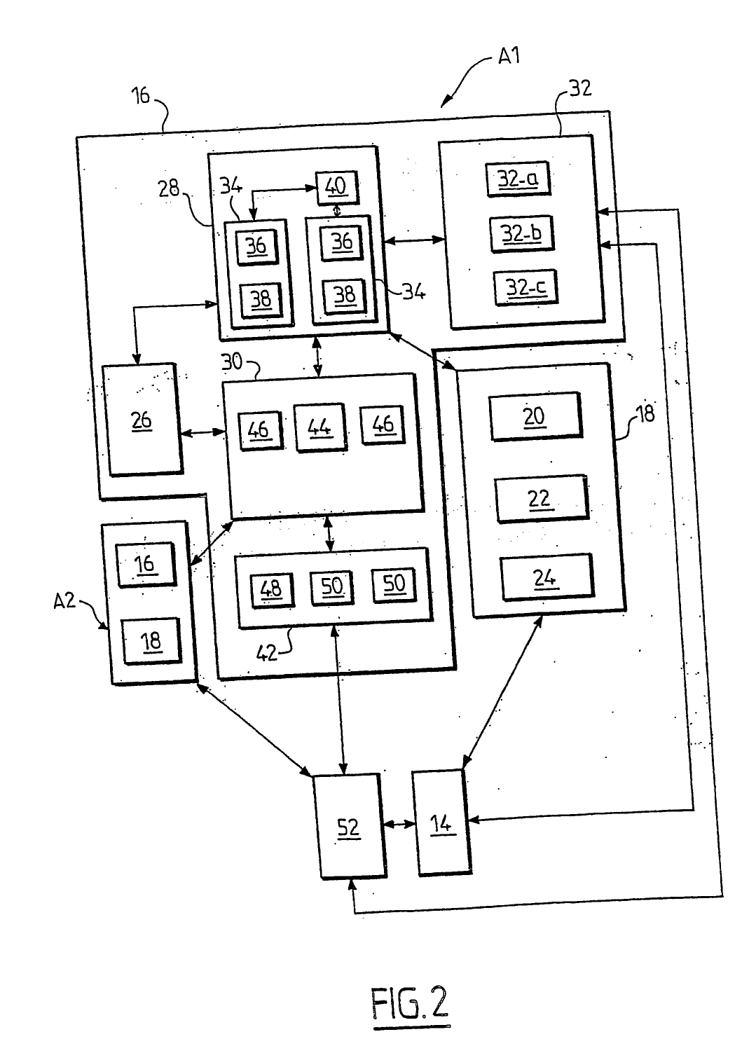

FIG. 2 is a block diagram illustrating the structure of an agent associated with the system of FIG. 1; and

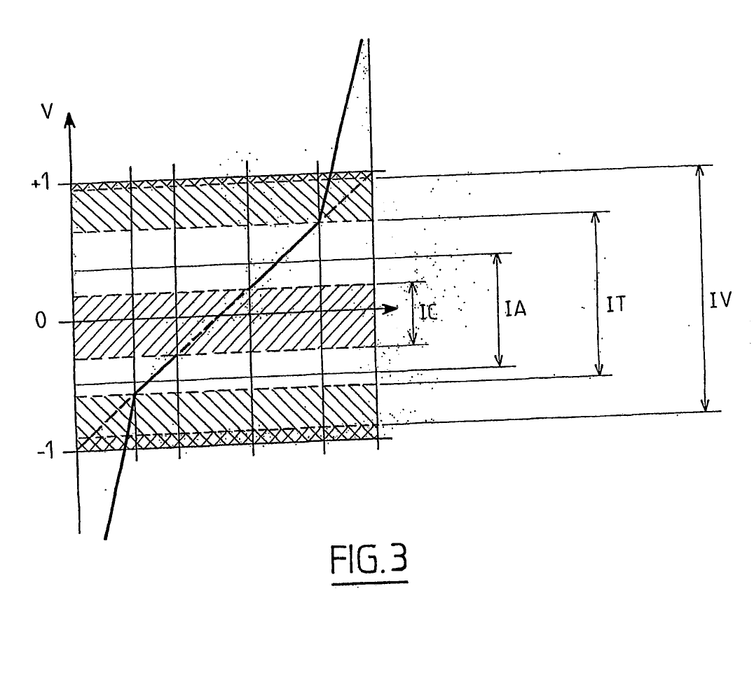

FIG. 3 shows the change in the state of an internal variable of the system of FIG. 1.

The general structure and the operation of an automatic system for decision-making by an agent, such as a robot, will be described hereinbelow, by way of example. This system mainly comprises a behavioral engine forming a software toolbox for configuring and developing computing applications using agents having autonomous behavior and, in particular, software applications intended to prepare the behavior of an agent, that is to drive the members for carrying out elementary functions or groups of functions of a robot or the like, as a function of variables internal to the agent and of variables external thereto.

More specifically, the invention makes it possible to prepare applications using agents having autonomous and nonpredictive behavior, whose change makes it possible to carry out forecasts, analyses of models or simulations.

The applications of such a system may relate to very varied fields such as the field of games, electronic commerce, market research or industrial or economic simulations.

The invention is implemented in the form of a behavioral engine and of layers specific to each application, having a set of databases. The following description will be based on an example where the virtual or physical agent, such as a robot, is representative of a human being and, in particular, whose behavior is representative of that of a human being.

Schematically, an application has a base layer consisting of the behavioral engine, managing the actions of the agents and managing conflicts. An outer layer is specific to a profession. It specifies the nature of the agents and their main characteristics. A third layer contains the elements specific to one applications type.

Each agent has variables characteristic of the agent's motivation, the agent's behavior, and parameters or variables representing the agent's personality together with innate or acquired knowledge.

The agent's motivation triggers one type of behavior or a set of behavior, which interact with the agent's environment. These actions are affected by the parameters and variables which are internal, that is to say specific, to the agent, by the other agents and by external events.

The overall structure of a system according to the invention will be described with reference to FIGS. 1 and 2, in which the data streams between the various elements coming within the system construction are shown by arrows. In this exemplary embodiment, only two agents A1 and A2 are managed by the system.

As indicated above, the system makes available to a user a set of computing tools, in the form of predetermined tool boxes consisting of software modules which can be parameterized by means of a suitable interface, in order to make it possible to configure each agent, in terms of external and internal characteristics in order to determine its behavior in response to requests or stimuli which can also be configured and parameterized, and to the environment in which the agent operates.

To do this, the system essentially comprises a first software part or layer, denoted by the general numerical reference 10, consisting of an interface with the real environment which can be used by the user, a second part 12 essentially consisting of databases encompassing all the parameterized agents and containing the behavioral engine, and a third part 14 consisting of databases in which a representation of the environment or of the world in which the agents operate is stored.

These elements are supplemented by a module 15 which can also be configured by the user, incorporated in the second part relating to the agents and in which are loaded the objects of the environment which surrounds an agent and incorporating information relating to these objects. For example, this module 15 is in the form of a database. This information is intended for the agent in order to allow it to take it into consideration during its reflection.

The first part can be used by the user in order to encode, configure and parameterize the agents so as to define their intrinsic and extrinsic characteristics, together with the environment.

For example, and in particular where the system is intended to manage decision-making by a robot, the assembly which has just been described is in the form of on-board hardware means, driving the various elements carrying out elementary functions of the robot via appropriate relays associated with storage means in which the dynamically modifiable toolboxes which can be parameterized by the user are loaded.

For each agent, the behavioral engine essentially breaks down into two parts, that is the actual engine, denoted by the general numerical reference 16, serving to define types of motivation, which create needs that the agent will seek to satisfy, such as eating, drinking, responding to an order, etc., by carrying out actions on the environment and a part called the representation and knowledge part 18, in which information relating to the environmental modeling in the third part 14 or to other agents is stored.

This part 16, that is to say the actual engine, has a motivation database comprising a plurality of motivation files each one having data relating to the types of behavior triggered, to the effect of the events perceived by the agent and to the effect of the agent's personality.

As is visible in FIG. 2, the representation and knowledge part 18 comprises a first module 20 in which each agent or class of agent is able to store data relating to knowledge which can be used by the agent in order to find solutions to its needs, a second module 22 in which is stored information relating to the representation made by a class of agents or an agent of another class of agents or of objects, and a third module 24 in which are loaded data relating to the representation made by each class of agents or agent of an instance of an agent or of an object.

The third part of the engine, denoted by the reference 26, is used to model the intrinsic state variables of the agent or of a class of agents, which makes it possible to configure several agents simultaneously, such as its intrinsic characteristics, for example its food preference, its attributes, that is to say for example the members or abilities made available to each agent, and the competences of each agent.

In the exemplary embodiment in question, after configuration by the user, the actual engine 16 contains three parts or modules, that is:

a motivational part 28,

a reactive part, and

a cognitive part,

the reactive and cognitive parts being brought together in the form of one and the same module 30.

The motivational part 28 is a module for calculating the motivations of the agent to respond to a psychological or physical need and to stimuli that it receives from a perception module 32.

As can be seen in FIG. 2, this perception module, which can also be configured by the user, is provided with perception means 32-a adapted to obtain from the environment 14 characteristics representative of the latter, means 32-b adapted to perceive the physical effects applied to the agent and, in particular, applied to the members for carrying out elementary functions activated, for example, in response to a stimuli, and means 32-c capable of perceiving communication signals emanating, for example, from other agents.

The motivational part 28, which comprises the motivation database, carries out modeling determining the psychological, physiological and emotional states of the agents, together with the resulting behavior of an agent, that is to say the behavior associated with biological needs (eating, drinking, resting etc.) and to psychological attitudes (fleeing, being aggressive, etc.)

More specifically, the motivational part 28 calculates the change with time of at least some of the means for motivating the agent using predetermined functions, and calculates the change of at least some of the motivation data as a function of configured and stored personality parameters of the agent and of configured and stored perception and/or knowledge variables, also by means of predetermined functions, or else as a function of the result of an action by the agent.

In addition, it periodically updates variables of several interacting agents, and periodically selects actions applied to each agent.

It comprises a set of modules 34 for preparing and calculating variables controlling the reactive part and the cognitive part 30, each of these modules comprising means 36 for calculating internal state variables varying with time and events external to motivation, such as the consumption of food or the presence of external stimuli, together with a module 38 for calculating control variables from internal state variables delivered by the computing means 36, for example by comparison with predetermined threshold values which can be parameterized.

In fact, as will be indicated hereinbelow, the state of each calculated motivation variable changes within a range of values going from a comfort range to an emergency range corresponding to near death of the agent and induces a relatively high motivation tending to activate behaviors or tasks having the aim of making the state in question return within the comfort range.

It will be noted that various models 34 are linked together such that the motivations can mutually be activated or inhibited.

Finally, the motivational part 28 comprises a stimulation module 40 receiving data coming from the perception module 32 and from the representation and knowledge part 18 in order to generate stimuli used by the computing means 36 in order to vary the internal state variables.

This stimulation module thus makes it possible to vary the internal state variables as a function of various stimuli such as the effect of surprise, habituation, etc. and as a function of the agent's knowledge relating, for example, to other agents or to objects in the environment.

More specifically, the motivational part is organized in functional layers, comprising:

means for preparing essential variables,

means for preparing intermediate variables,

means for preparing motivation variables.

As indicated above, environmental stimuli are added to these three functional layers, in the form of messages which operate in the same way as requests (perception by the agent of an element from its environment), which supply internal detection variables. This is a form of immediate feedback from the environment.

With regard to the essential variables, these consist, for example, of survival variables or of additional variables.

They define the biological and psychological state of the person. They are objective variables. They define the state of the agent, but not what the agent feels. For example, it involves the degree of body hydration, tiredness, pain, etc.

They change depending on the action taken or not taken by the agent. For example, tiredness increases while the agent walks, and decreases when the agent rests. Similarly, the degree of hydration increases depending on what the agent has been able to swallow, etc. FIG. 3 shows the change in state of a variable.

As indicated above, and with reference to FIG. 3 in which the change of a variable V is shown, all the variables V have a comfort range IC. In this region, the agent is in a perfectly normal state. Outside this comfort region, the engine generates a motivation, for example thirst, which will trigger behavior aiming to satisfy this motivation.

Thus, each variable also has an alarm range IA on the basis of which an action has to be carried out urgently in order to return the variable to within the comfort range IC, and a tolerance range IT which corresponds to a range in which tolerance to the corresponding state is reduced, and a viability range IV on the basis of which the state corresponding to the increase in the variable is intolerable (possibly syncope or death).

The biological system of the agent is designed (for example, when the degree of hydration of the agent is very low, he has a syncope due to the effect of the variable on the model, but not due to an additional mechanism which would supervise each variable) in order to return the variable to within the comfort range, when it goes outside it (for example an agent will probably die more quickly if he stops drinking than if he drinks too much). During configuration, the user must thus make sure that the system naturally stabilizes. For example, he must prevent the increase of one variable leading to the increase of the same variable through feedback.

If the variable moves further away from its comfort range, it may go outside the alarm range (for example, the information “thirst” is constructed on the basis of the survival variable “degree of hydration” and the stimulus “presence of water. The information “thirst” is stored in an intermediate variable. This variable may cause the “rehydrate” behavior, it is then called motivation, but may also be used to calculate the intermediate variable “agitation”).

All the variables are limited by the saturation limits (for example, the information “thirst” is constructed on the basis of the survival variable “degree of hydration” and the stimulus “presence of water”. The information “thirst” is stored in an intermediate variable. This variable may cause the “rehydrate” behavior, it is then called motivation, but is also used to calculate the intermediate variable “agitation”).

On moving further away, the variable may go outside the tolerance range (for example, the intermediate variable “thirst” is slightly activated by the stimulus “presence of water”, and inhibited by the essential variable “fear” and is very dependent on the “degree of hydration”). Outside this range, the effect of the variable is increased the more it approaches the saturation limits. This corresponds to an emergency situation which must be taken into account as a priority.

An essential variable outside the viability range can no longer return naturally therewithin. The agent is then in a psychotic state or dies. When going outside the viability range leads to death of the agent, the variable is called survival variable (examples: degree of hydration, tiredness, etc.). The other variables are called additional variables (nobody dies from curiosity or from the feeling of insecurity).

There is no mechanism for supervising variables which triggers particular emergency behaviors when the variables reach extreme values: it is the effect of the variables on the model which implicitly defines the emergency behavior.

The behavior at the limits of each range is fixed differently according to each variable.

The variable of the curve for reading the value is also weighted when it is used in the psychological and biological model.

With regard to the curves showing the change of internal state variables, it will be noted that the change of a variable V is a linear function of the other variables and of time.

V_{n+I}=Vₙ+V_{n′}·Dt

where V_{n′}=V_{n′+} or V_{n′} depending on whether the variable is increased or decreased and V_{n′+}=f₊ (Vₙ, increments), V_{n′}=f (Vₙ, decrements).

As for the intermediate variables, they are tools which make it possible to synthesize information coming from the essential variables and from the external stimuli (this avoids having too many connections between the essential variables and the motivated behaviors). This synthetic information is used for other intermediate variables or to define a motivation for the agent (for example, the information “thirst” is constructed on the basis of the survival variable “degree of hydration” and the stimulus “presence of water. The information “thirst” is stored in an intermediate variable. This variable may lead to the “rehydrate” behavior, it is then called motivation, but may also be used in order to calculate the intermediate variable “agitation”).

With regard to the change in intermediate variables and input factors, the information coming from an essential variable may be taken into account, qualitatively and quantitatively, in different ways [for example the intermediate variable “thirst” is slightly activated by the stimulus “presence of water”, and inhibited by the essential variable “fear” and is very dependent on the “degree of hydration”]: inhibition, activation, function of.

The cognitive and reactive parts, consisting of the previously mentioned module 30, form the behavioral part of the system. They are activated by the motivational part 28 and drive an action management module 42 for the purpose of selecting actions to be carried out.

The cognitive part, which makes it possible to model more complex and higher performance agents, contains an order management system.

The reactive part consists of instances of behaviors associated with an aim capable either of being broken down or of directly activating an elementary action. It may be triggered by the motivational part or by the cognitive part of the architecture.

The behavioral part consists of a hierarchy of behaviors capable of being instantiated. As can be seen in FIG. 2, this behavioral part consists of a set of modules in the form of behavior databases.

In this database, each behavior is defined by a set of computing routines and by parameters determining the effects on at least one motivation. As will be described hereinbelow, this database is associated with computing means in order to select a type of behavior or a sequence of behaviors acting on the agent as a function of the result of a predetermined function for changing the motivation data of the agent.

In the exemplary embodiment in question, these modules comprise a module 44 corresponding to reactive behavior intended to cause an action to be carried out directly or indirectly by the action management module 42 as soon as a triggering condition has been calculated by the motivational part, together with two modules 46 corresponding to a cognitive behavior, that is to say a behavior storing the intentions that the agent has of doing something. Unlike the reactive behavior, when the context or the conditions which have created an instance of the task have disappeared, the instance may continue to exist according to criteria defined in the databases by the user.

The cognitive behavior modules comprise, for example, a behavior database having behavior files which may also comprise data relating to the triggered behavior sequences, to the lists of triggered actions, to the effect of events perceived by the agent, to the effect of the agent's knowledge, and to the effect of the agent's personality.

Furthermore, these modules may comprise an action database comprising a plurality of action files, each one comprising data relating to the consequences of the action on the environment and to the consequences of the action on the motivations, or to a scenario database.

It will be noted that the information supplied by the behavior modules 44 and 46 are, at this stage, differentiated by communication actions to be carried out, that is to say, actions by which the agent transmits a message for the attention of other agents, and by general actions to be carried out, that is to say actions other than communication actions.

Thus, the action management module 42 is provided with a submodule 48 managing and selecting communication actions to be carried out, together with two submodules 50 managing and selecting general actions.

These submodules 48 and 50 then drive the member or members 52 for carrying out elementary functions in question, which results in modifying the variable having caused the execution of this function and, where appropriate, modifying the environment 14.

It will be noted that each behavior instance may either be broken down into a list of subbehaviors, or directly activate elementary actions.

The role of a motivated behavior consists in triggering one or more behaviors associated with one aim by virtue of using a filing system (production rules).

Each motivated behavior is directly associated with a motivation (or intermediate variable) which triggers it depending on the following factors:

a corresponding motivation level,

activation (or inhibition) of (external or internal) stimuli,

activation (or inhibition) of elements present in the representation.

The behaviors associated with an aim which can be broken down can be broken down into subbehaviors associated with an aim by virtue of using a filing system (production rules). This system is of the same type as that used by the motivated behaviors, that is to say that it is capable of:

containing variables and instantiating them, and

propagating activity.

Thus, a behavior “go₁₃ toward (adjacent room)” may be broken down into “open₁₃ door” if the door which separates the agent from the room in question is closed.

Each behavior associated with an aim is encoded in the architecture by a behavior associated with a general aim. At the time of triggering a behavior associated with a particular aim, the general aim, which is a variable, is instantiated, which produces a behavior associated with an aim.

In the example of rules described in the paragraph relating to the motivated behaviors, if X is a banana and Y a roasted wild boar, the agent “obelix” will trigger two behaviors associated with one aim: eat (banana) and go toward (location (wild boar)).

When some behaviors associated with an aim cannot be broken down, they are then reduced to elementary actions which can be directly carried out by the agent.

The behavior “eat (banana)” is an example of behavior associated with one aim (the banana) which is reduced to one action (to eat).

With regard to the management and selection of behaviors, the conditions and actions of the rules for activating one or more actions have the following form:

If <Condition1 (X1)> and <Condition2 (X2)> . . . and <Condition(Xn)> Then <Action (x1, x2, Xn)>

A rule is triggered when the conditions match the current situation for particular values of Xi.

The parameterized action message “Action(object1, object2, object3)” is then activated and instantiated with the particular Xi values which generates behavior associated with a parameterized aim.

Furthermore, the behavioral part 30 and the module 42 for managing and selecting actions implements an activity propagation procedure.

Activity propagation consists in propagating, inside the behavioral part, the values generated by the motivational part so as to calculate the benefit of each instantiated action at the end of the sequence.

To calculate the activity received by a subbehavior SC on behalf of a behavior C by virtue of activating a rule R, the following values are used:

the current activity of C,

the force of the messages which are matched with the conditions for triggering R,

the weight of each of these conditions,

the force of the rule R.

For example, the force of the action message Action(object1, object 2, objectn) of the rule R of the previous paragraph is calculated by the following equation:

Force R.=(ΣiForce (Conditioni(objecti)). Weight (Conditioni))

where Σi Weight (Conditioni)=1 (for the sake of standardization) and in which Force (Conditioni (objecti)) gives the matching force.

One of the property of the propagation is to be able to accumulate, at behavior or action level, an activity set coming from several sources.

Propagating the activity in the instantiated behavior network leads to constructing a list of instantiated actions. Each of these actions is associated with a force which represents the total activity that it has received from the network.

The selection of actions consists in choosing, from this list of instantiated actions, all the incompatible actions which have the largest forces.

The following description explains in detail the cognitive tasks present in the cognitive part of the engine. The structure of these tasks is constructed as a general implementation of the behavior modules used up to now in the reaction part.

The parameterization of this behavior structure makes it possible to produce both cognitive tasks or behavior modules whose functionalities will then be increased.

These are the properties obtained at operational level of the cognitive tasks:

A cognitive task represents a memory of that which has to be done by the agent. Therefore it must not disappear from one iteration to another of the engine.

A cognitive task may be activated by a point-like event and remains active when the corresponding condition has disappeared.

However, the force of a cognitive task may decrease over time when the event no longer recurs.

A cognitive task is associated with a shutdown condition which causes it to finish.

A cognitive task may also finish when no other task activates it.

To achieve the objectives set above, a novel class of behaviors is defined, which contains, like the current behavior modules, a set of rules for breaking down into subbehaviors.

For each agent, each of these behaviors may have a set of instances.

The force of each instance is calculated from the force of the instances of the father behavior or behaviors which have activated it.

In addition, the novel behavior class may contain:

the maximum number of instances of son behaviors which this behavior has the right to activate,

the maximum number of instances of son behaviors which this behavior can store,

an existence threshold below which the instance must be removed,

a breakdown threshold below which the instance does not have the right to be broken down,

an activation threshold below which the activity generated by a rule should not be propagated,

a forgetting factor associated with each breakdown rule.

With each instance of the novel behavior class is associated:

a shutdown condition: CA (x),

a Boolean saying whether the shutdown condition is verified,

the number of instances of father behavior which have activated this instance,

a memory of the instances of son behaviors that this instance has activated or wishes to activate. This memory must contain, for each instance of son behavior:

1. A link to the rules which have activated it and the force received from each of these rules.

2. The total force of the instance to be activated and which combines the forces of the various rules which send the activity thereto.

It is possible to limit the behavior activations without losing information concerning the other behaviors that it will be possible to trigger later on, even if the event is no longer present.

Although the way of configuring the system according to the invention by configuring characteristics intrinsic and extrinsic to each agent, characteristics of the environment in which it is located and objects that it perceives and actions to be carried out in response, especially to stimuli, have been explained in the foregoing, it should be noted that, during this prior phase of configuring the system, links between the various elements of the system are configured so that a modification of an element leads to a consecutive modification of another element.

Thus, for example, this configuration may consist, as can be seen in FIG. 2, in creating and parameterizing links between the modules 34 for preparing and calculating control variables of the reactive part and of the cognitive part in a way such that a modification of an internal state variable generates a consecutive modification of another variable to which it is linked.

Hence it is possible, for example, to ensure that increasing an internal variable corresponding to a sensation of fear in an agent generates a decrease in a sensation of thirst felt by the latter.

Finally, it will be noted that, preferably, the system according to the invention preferably incorporates means for learning at least some of the internal variables, for example exhibited in the form of lines of code included in the modules involved in its construction, in particular the modules of the motivational part and of the behavioral part.

Definitions:

Request: mechanism for consulting knowledge or, in general, mechanism for consulting information which the agent has available, used in the reactive and cognitive parts, by means of which an agent may understand a characteristic of its environment.

Rule: combination of a condition(s), action (subbehavior or elementary action), force part. The conditions are constructed on the basis of requests.

Behavior: set of elementary subbehaviors or actions.

1. An automatic system for decision-making by a virtual or physical agent as a function of external variables derived from an environment described by a digital model, and of variables internal to the agent described by digital parameters, comprising means (42) for selecting actions to be carried out by the agent based on varying one or more of said variables, characterized in that the digital parameters describing the virtual or physical agent include digital data representing the agent's motivation, and in that the virtual or physical agent's selection of actions is also based on the value of said data representing the agent's motivation.

2. The automatic system for decision-making by a virtual or physical agent as claimed in claim 1, characterized in that it comprises a means (36) for changing the value of at least some of the motivation data with time.

3. The automatic system for decision-making by a virtual or physical agent as claimed in claim 1 or 2, characterized in that the virtual or physical agent includes at least one personality parameter and in that the system comprises computing means (36) in order to change the value of at least some of the motivation data as a function of the value of said personality parameters.

4. The automatic system for decision-making by a virtual or physical agent as claimed in any one of the preceding claims, characterized in that it includes means for configuring at least one variable for the agent's perception and/or knowledge in that the system includes computing means (36) in order to change the value of at least some of the motivation data as a function of the value of said perception and/or knowledge parameters.

5. The automatic system for decision-making by a virtual or physical agent as claimed in any one of the preceding claims, characterized in that the system includes computing means (36) in order to change the value of at least some of the motivation data of a virtual or physical agent as a function of the result of an action of said agent or of other agents or as a function of the environment.

6. The automatic system for decision-making by a virtual or physical agent as claimed in any one of the preceding claims, characterized in that it includes a behavior database (30) associated with the virtual agent or agents, each type of behavior being defined by a set of computing routines and by parameters determining the effect on at least one type of motivation, and computing means (42) for selecting one type of behavior or a sequence of behaviors acting on a virtual or physical agent as a function of the result of a function of changing the motivation data of said virtual or physical agent.

7. The automatic system for decision-making by a virtual or physical agent as claimed in any one of the preceding claims, characterized in that it includes computing means (28) for periodically updating variables of one or more interacting virtual agents, and for periodically selecting actions applied to the agent or to each of said agents.

8. The automatic system for decision-making by a virtual or physical agent as claimed in any one of the preceding claims, characterized in that it includes a database (26) comprising a plurality of agents, each one described by a class, by data for motivation, behavior, actions, events perceived by the agent, personality and knowledge.

9. The automatic system for decision-making by a virtual or physical agent as claimed in claim 8, characterized in that it includes a motivation database (46) comprising a plurality of motivation files each one comprising data relating to the triggered types of behavior, to the effect of the events perceived by the agent and to the effect of the agent's personality.

10. The automatic system for decision-making by a virtual or physical agent as claimed in claim 9, characterized in that it includes a behavior database (30) comprising a plurality of behavior files each one comprising data relating to the triggered behavior sequences, to the lists of triggered actions, to the effect of the agent's personality and the effect of the agent's knowledge.

11. The automatic system for decision-making by a virtual or physical agent as claimed in either of claims 9 and 10, characterized in that it includes an action database (30) comprising a plurality of action files each one comprising data relating to the consequences of the action on the environment and to the consequences of the action on the types of motivation.

12. The automatic system for decision-making by a virtual or physical agent as claimed in any one of claims 9 to 11, characterized in that it includes a database (14) for describing the world in which the virtual agents operate.

13. The automatic system for decision-making by a virtual or physical agent as claimed in any one of claims 9 to 12, characterized in that it includes a scenario database (30).

14. The automatic system for decision-making by a virtual or physical agent as claimed in any one of claims 9 to 13, characterized in that it includes means for learning at least some of the internal variables.

15. A method of managing the operation of a virtual or physical agent, which comprises configuring and modeling the agent, configuring and modeling an environment in which the agent is located, preparing variables external and internal to the agent, and selecting actions as a function of variations in one or in several external or internal variables, characterized in that modeling the agent comprises preparing and configuring digital data representing the agent's motivation, and in that selecting actions for the virtual or physical agent comprises selecting said actions as a function of the value of said data representing the agent's motivation.
